(19) United States
(12) Patent Application Publication
(10) Pub. No.: US 2016/0046731 A1
(43) Pub. Date: Feb. 18, 2016

(54) PRODUCTION OF SUGARS FROM BIOMASS USING SOLID CATALYSTS

(71) Applicant: API Intellectual Property Holdings, LLC, Atlanta, GA (US)

(72) Inventor: Theodora RETSINA, Atlanta, GA (US)

(21) Appl. No.: 14/826,191

(22) Filed: Aug. 13, 2015

Related U.S. Application Data
(60) Provisional application No. 62/037,220, filed on Aug. 14, 2014.

(51) Int. Cl. C08B 1/00

(52) U.S. Cl. CPC C08B 1/003

(57) ABSTRACT

The invention provides a process for producing sugars from lignocellulosic biomass, comprising: drying lignocellulosic biomass; hydrolyzing the dried feedstock with a hydrolysis catalyst to reach high conversion of cellulose and hemicellulose to sugars; washing and/or separating the sugars from the residual solids (containing lignin and catalyst); combusting the residual solids to burn the lignin and produce an ash stream comprising the hydrolysis catalyst; recycling the ash stream comprising the hydrolysis catalyst to the hydrolysis reactor; and recovering the sugars. Some variations envision drying a feedstock (e.g., sugarcane straw) with flue gas, then mixing with catalysts, rotating until hydrolysis is completed, separating sugars, washing out catalyst and lignin, burning catalyst and lignin and collecting catalyst from the bottom of a fluidized bed to recycle the catalyst to the front (with fresh biomass). Alternatively, the catalyst may be first separated from lignin and only the lignin is burned.

### PRIORITY DATA

This patent application is a non-provisional application claiming priority to U.S. Provisional Patent App. No. 62/037,220, filed Aug. 14, 2014, which is hereby incorporated by reference herein.

### FIELD

The present invention generally relates to processes for converting lignocellulosic biomass into fermentable sugars and co-products.

### BACKGROUND

Biomass refining (or biorefining) is becoming more prevalent today. Cellulose fibers and sugars, hemicellulose sugars, lignin, syngas, and derivatives of these intermediates are being used by many companies for chemical and fuel production. Indeed, we now are observing the commercialization of integrated biorefineries that are capable of processing incoming biomass much the same as petroleum refineries now process crude oil. Underutilized lignocellulosic biomass feedstocks have the potential to be much cheaper than petroleum, on a carbon basis, as well as much better from an environmental life-cycle standpoint.

Lignocellulosic biomass is the most abundant renewable material on the planet and has long been recognized as a potential feedstock for producing chemicals, fuels, and materials. Lignocellulosic biomass normally comprises primarily cellulose, hemicellulose, and lignin. Cellulose and hemicellulose are natural polymers of sugars, and lignin is an aromatic/aliphatic hydrocarbon polymer reinforcing the entire biomass network.

There is currently a need in the art for processes and apparatus that can convert these lignocellulosic biomass into fermentable sugars, such as glucose, or other valuable products (or materials to be reused). The sugars can be fermented to ethanol or other products. There is particularly a desire to utilize solid hydrolysis catalysts without large amounts of water present, so that concentrated sugar streams may be produced.

### SUMMARY

In some variations, the invention provides a process for producing sugars from lignocellulosic biomass, the process comprising:

(a) drying a feedstock comprising lignocellulosic biomass to produce a dried feedstock with a moisture content of about 5 wt % or less;

(b) introducing the dried feedstock and a solid hydrolysis catalyst into a hydrolysis reactor;

(c) in the hydrolysis reactor, hydrolyzing the dried feedstock in the presence of the hydrolysis catalyst and under effective hydrolysis reactor conditions, to reach at least 50% conversion of cellulose and hemicellulose to sugars, wherein the sugars are in combination with residual solids comprising lignin and the hydrolysis catalyst;

(d) washing and/or separating the sugars from the residual solids;

(e) combusting the residual solids to burn the lignin and produce an ash stream comprising the hydrolysis catalyst;

(f) recycling at least a portion of the ash stream comprising the hydrolysis catalyst to the hydrolysis reactor; and

(g) recovering or further processing the sugars.

In some embodiments, step (a) utilizes flue gas for the drying. The flue gas may be derived from the combusting in step (e). The moisture content may be about 2 wt % or less, or about 1 wt % or less, for example. In certain embodiments, the dried feedstock contains essentially no moisture, i.e. is completed dried. If the starting feedstock already is sufficiently dry, then step (a) may be omitted.

In preferred embodiments, the solid hydrolysis catalyst is a mineral that is hydrated with H₂O to some extent, so that water for hydrolysis is available. That is, the hydrolysis catalyst may contribute the water molecule (or the H and OH). Unlike an acid catalyst in an aqueous solution in which bulk-phase water is incorporated into the sugar molecules when polysaccharides are hydrolyzed, here (without being limited by theory) the solid hydrolysis catalyst is hydrated and can directly catalyze sugar formation as well as provide the stoichiometric amounts of water to complete the hydrolysis.

Many minerals are possible. In some embodiments, the mineral is a clay mineral based on hydrous aluminum phyllosilicates. For example, the mineral may be selected from the Kaolin group which includes kaolinite, dickite, halloysite, nacrite, other polymorphs of Al₂Si₂O₅(OH)₄, and combinations thereof. In various embodiments, the mineral is selected from the montmorillonites group of phyllosilicate minerals, the mica group of phyllosilicate minerals, the smectite group of phyllosilicate minerals, the illite group of phyllosilicate minerals, or the chlorite group of phyllosilicate minerals.

In other embodiments, the solid hydrolysis catalyst is a non-mineral, provided that the solid hydrolysis catalyst is hydrated with H₂O to some extent so that water for hydrolysis is available.

In some embodiments, the hydrolysis reactor is a rotating reactor. In some embodiments, the hydrolysis reactor is a fluidized reactor.

Optionally, step (d) may be integrated with step (c) to separate the sugars from the residual solids directly from the hydrolysis reactor. In some embodiments, step (c) utilizes a non-aqueous solvent for lignin. In these or other embodiments, step (d) utilizes a solvent for lignin.

The effective hydrolysis reactor conditions may include a temperature of from about 50° C. to about 200° C., such as from about 100° C. to about 150° C. The effective hydrolysis reactor conditions include a hydrolysis time of from about 30 minutes to about 24 hours, such as from about 2 hours to about 10 hours.

Preferably, step (c) achieves at least 70% conversion of cellulose and hemicellulose to sugars, at least 90% conversion of cellulose and hemicellulose to sugars, or at least 95% conversion of cellulose and hemicellulose to sugars.

Step (d) may be configured in various ways. In some embodiments, step (d) comprises washing the residual solids and then separating the sugars from the residual solids. In some embodiments, step (d) comprises separating at least some of the sugars from the residual solids and then washing the residual solids to recover additional sugars. Alternatively, step (d) may comprise simultaneously washing and separating the sugars from the residual solids.

In some embodiments, step (e) utilizes a fluidized bed for combusting the residual solids to burn the lignin and produce an ash stream comprising the hydrolysis catalyst. The ash stream can be collected from the bottom of the fluidized bed unit.

In some embodiments, step (f) comprises separating out the hydrolysis catalyst from the ash stream, and then recycling recovered hydrolysis catalyst to the hydrolysis reactor. In these or other embodiments, step (f) comprises recycling at least a portion of the ash stream directly to the hydrolysis reactor.

Other variations provide a process for producing sugars from lignocellulosic biomass, the process comprising:

(a) drying a feedstock comprising lignocellulosic biomass to produce a dried feedstock with a moisture content of about 5 wt % or less;

(b) introducing the dried feedstock and a solid hydrolysis catalyst into a hydrolysis reactor;

(c) in the hydrolysis reactor, hydrolyzing the dried feedstock in the presence of the hydrolysis catalyst and under effective hydrolysis reactor conditions, to reach at least 50% conversion of cellulose and hemicellulose to sugars, wherein the sugars are in combination with residual solids comprising lignin and the hydrolysis catalyst;

(d) washing and/or separating the sugars from the residual solids;

(e) separating the hydrolysis catalyst from the lignin to generate recovered hydrolysis catalyst and residual lignin;

(f) recycling at least a portion of the recovered hydrolysis catalyst to the hydrolysis reactor;

(g) combusting the residual lignin; and

(h) recovering or further processing the sugars.

Other variations provide a process for producing sugars from lignocellulosic biomass, the process comprising:

(a) pretreating a feedstock comprising lignocellulosic biomass using steam or hot-water extraction;

(b) drying pretreated feedstock from step (a) to produce a dried feedstock with a moisture content of about 5 wt % or less;

(c) introducing the dried feedstock and a solid hydrolysis catalyst into a hydrolysis reactor;

(d) in the hydrolysis reactor, hydrolyzing the dried feedstock in the presence of the hydrolysis catalyst and under effective hydrolysis reactor conditions, to reach at least 50% conversion of cellulose to sugars, wherein the sugars are in combination with residual solids comprising lignin and the hydrolysis catalyst;

(e) washing and/or separating the sugars from the residual solids;

(f) combusting the residual solids to burn the lignin and produce an ash stream comprising the hydrolysis catalyst;

(g) recycling at least a portion of the ash stream comprising the hydrolysis catalyst to the hydrolysis reactor; and

(h) recovering or further processing the sugars.

Other variations provide a process for producing sugars from lignocellulosic biomass, the process comprising:

(a) pretreating a feedstock comprising lignocellulosic biomass using digestion with an acid, solvent for lignin, and water;

(b) drying pretreated feedstock from step (a) to produce a dried feedstock with a moisture content of about 5 wt % or less;

(c) introducing the dried feedstock and a solid hydrolysis catalyst into a hydrolysis reactor;

(d) in the hydrolysis reactor, hydrolyzing the dried feedstock in the presence of the hydrolysis catalyst and under effective hydrolysis reactor conditions, to reach at least 50% conversion of cellulose to sugars, wherein the sugars are in combination with residual solids comprising lignin and the hydrolysis catalyst;

(e) washing and/or separating the sugars from the residual solids;

(f) combusting the residual solids to burn the lignin and produce an ash stream comprising the hydrolysis catalyst;

(g) recycling at least a portion of the ash stream comprising the hydrolysis catalyst to the hydrolysis reactor; and

(h) recovering or further processing the sugars.

Other variations provide a process for producing sugars from lignocellulosic biomass, the process comprising:

(a) pretreating a feedstock comprising lignocellulosic biomass using digestion with an acid, solvent for lignin, and water;

(b) drying a feedstock comprising lignocellulosic biomass to produce a dried feedstock with a moisture content of about 5 wt % or less;

(c) introducing the dried feedstock and a solid hydrolysis catalyst into a hydrolysis reactor;

(d) in the hydrolysis reactor, hydrolyzing the dried feedstock in the presence of the hydrolysis catalyst and under effective hydrolysis reactor conditions, to reach at least 50% conversion of cellulose and hemicellulose to sugars, wherein the sugars are in combination with residual solids comprising lignin and the hydrolysis catalyst;

(e) washing and/or separating the sugars from the residual solids;

(f) separating the hydrolysis catalyst from the lignin to generate recovered hydrolysis catalyst and residual lignin, wherein the solvent for lignin from step (a), or a digestion liquor derived from step (a), is utilized to remove the lignin from the hydrolysis catalyst;

(g) recycling at least a portion of the recovered hydrolysis catalyst to the hydrolysis reactor; and

(h) recovering or further processing the sugars.

### DETAILED DESCRIPTION OF SOME EMBODIMENTS

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with any accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs. All composition numbers and ranges based on percentages are weight percentages, unless indicated otherwise. All ranges of numbers or conditions are meant to encompass any specific value contained within the range, rounded to any suitable decimal point.

Unless otherwise indicated, all numbers expressing parameters, reaction conditions, concentrations of components, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Some variations of the invention are premised on the realization that some mineral charged catalysts work well only with about 0% moisture. To overcome this limitation, some variations envision drying a feedstock (e.g., sugarcane straw) with flue gas, then mixing with catalysts, rotating until hydrolysis is completed, separating sugars, washing out catalyst and lignin, burning catalyst and lignin and collecting catalyst from the bottom of a fluidized bed to recycle the catalyst to the front (with fresh biomass). Alternatively, the catalyst may be first separated from lignin and only the lignin is burned.

Certain exemplary embodiments of the invention will now be described. These embodiments are not intended to limit the scope of the invention as claimed. The order of steps may be varied, some steps may be omitted, and/or other steps may be added. Reference herein to first step, second step, etc. is for illustration purposes only.

In some variations, the invention provides a process for producing sugars from lignocellulosic biomass, the process comprising:

(a) drying a feedstock comprising lignocellulosic biomass to produce a dried feedstock with a moisture content of about 5 wt % or less;

(b) introducing the dried feedstock and a solid hydrolysis catalyst into a hydrolysis reactor;

(c) in the hydrolysis reactor, hydrolyzing the dried feedstock in the presence of the hydrolysis catalyst and under effective hydrolysis reactor conditions, to reach at least 50% conversion of cellulose and hemicellulose to sugars, wherein the sugars are in combination with residual solids comprising lignin and the hydrolysis catalyst;

(d) washing and/or separating the sugars from the residual solids;

(e) combusting the residual solids to burn the lignin and produce an ash stream comprising the hydrolysis catalyst;

(f) recycling at least a portion of the ash stream comprising the hydrolysis catalyst to the hydrolysis reactor; and

(g) recovering or further processing the sugars.

The feedstock may be a hardwood, softwood, forest residue, agricultural residue, cellulose-containing waste material, hemicellulose-containing waste material, or combinations thereof. Also the feedstock may be a pretreated form of any of these feedstocks, such as to remove or decrease lignin content, hemicellulose content, or ash content, for example. The particle size of the feedstock may be adjusted prior to using in these processes, if desired.

In some embodiments, step (a) utilizes flue gas for the drying. The flue gas may be derived from the combusting in step (e). The moisture content may be about 2 wt % or less, or about 1 wt % or less, for example. In certain embodiments, the dried feedstock contains essentially no moisture, i.e. is completed dried. If the starting feedstock already is sufficiently dry, then step (a) may be omitted.

In preferred embodiments, the solid hydrolysis catalyst is a mineral that is hydrated with H₂O to some extent, so that water for hydrolysis is available. That is, the hydrolysis catalyst may contribute the water molecule (or the H and OH). Unlike an acid catalyst in an aqueous solution in which bulk-phase water is incorporated into the sugar molecules when polysaccharides are hydrolyzed, here (without being limited by theory) the solid hydrolysis catalyst is hydrated and can directly catalyze sugar formation as well as provide the stoichiometric amounts of water to complete the hydrolysis.

Many minerals are possible. In some embodiments, the mineral is a charged (i.e., having a surface charge) clay mineral based on hydrous aluminum phyllosilicates. For example, the mineral may be selected from the Kaolin group which includes kaolinite, dickite, halloysite, nacrite, other polymorphs of Al₂Si₂O₅(OH)₄, and combinations thereof. In various embodiments, the mineral is selected from the montmorillonites group of phyllosilicate minerals, the mica group of phyllosilicate minerals, the smectite group of phyllosilicate minerals, the illite group of phyllosilicate minerals, or the chlorite group of phyllosilicate minerals.

In other embodiments, the solid hydrolysis catalyst is a non-mineral, provided that the solid hydrolysis catalyst is hydrated with H₂O to some extent so that water for hydrolysis is available. The non-mineral hydrolysis catalyst may be a charged solid catalyst.

In some embodiments, the hydrolysis reactor is a rotating reactor. In some embodiments, the hydrolysis reactor is a fluidized reactor.

Optionally, step (d) may be integrated with step (c) to separate the sugars from the residual solids directly from the hydrolysis reactor. In some embodiments, step (c) utilizes a non-aqueous solvent for lignin. In these or other embodiments, step (d) utilizes a solvent for lignin.

The effective hydrolysis reactor conditions may include a temperature of from about 50° C. to about 200° C., such as from about 100° C. to about 150° C. The effective hydrolysis reactor conditions include a hydrolysis time of from about 30 minutes to about 24 hours, such as from about 2 hours to about 10 hours.

Preferably, step (c) achieves at least 70% conversion of cellulose and hemicellulose to sugars, at least 90% conversion of cellulose and hemicellulose to sugars, or at least 95% conversion of cellulose and hemicellulose to sugars.

Step (d) may be configured in various ways. In some embodiments, step (d) comprises washing the residual solids and then separating the sugars from the residual solids. In some embodiments, step (d) comprises separating at least some of the sugars from the residual solids and then washing the residual solids to recover additional sugars. Alternatively, step (d) may comprise simultaneously washing and separating the sugars from the residual solids.

In some embodiments, step (e) utilizes a fluidized bed for combusting the residual solids to burn the lignin and produce an ash stream comprising the hydrolysis catalyst. The ash stream can be collected from the bottom of the fluidized bed unit.

In some embodiments, step (f) comprises separating out the hydrolysis catalyst from the ash stream, and then recycling recovered hydrolysis catalyst to the hydrolysis reactor. In these or other embodiments, step (f) comprises recycling at least a portion of the ash stream directly to the hydrolysis reactor.

Other variations provide a process for producing sugars from lignocellulosic biomass, the process comprising:

(a) drying a feedstock comprising lignocellulosic biomass to produce a dried feedstock with a moisture content of about 5 wt % or less;

(b) introducing the dried feedstock and a solid hydrolysis catalyst into a hydrolysis reactor;

(c) in the hydrolysis reactor, hydrolyzing the dried feedstock in the presence of the hydrolysis catalyst and under effective hydrolysis reactor conditions, to reach at least 50% conversion of cellulose and hemicellulose to sugars, wherein the sugars are in combination with residual solids comprising lignin and the hydrolysis catalyst;

(d) washing and/or separating the sugars from the residual solids;

(e) separating the hydrolysis catalyst from the lignin to generate recovered hydrolysis catalyst and residual lignin;

(f) recycling at least a portion of the recovered hydrolysis catalyst to the hydrolysis reactor;

(g) combusting the residual lignin; and

(h) recovering or further processing the sugars.

Other variations provide a process for producing sugars from lignocellulosic biomass, the process comprising:

(a) pretreating a feedstock comprising lignocellulosic biomass using steam or hot-water extraction;

(b) drying pretreated feedstock from step (a) to produce a dried feedstock with a moisture content of about 5 wt % or less;

(c) introducing the dried feedstock and a solid hydrolysis catalyst into a hydrolysis reactor;

(d) in the hydrolysis reactor, hydrolyzing the dried feedstock in the presence of the hydrolysis catalyst and under effective hydrolysis reactor conditions, to reach at least 50% conversion of cellulose to sugars, wherein the sugars are in combination with residual solids comprising lignin and the hydrolysis catalyst;

(e) washing and/or separating the sugars from the residual solids;

(f) combusting the residual solids to burn the lignin and produce an ash stream comprising the hydrolysis catalyst;

(g) recycling at least a portion of the ash stream comprising the hydrolysis catalyst to the hydrolysis reactor; and

(h) recovering or further processing the sugars.

Other variations provide a process for producing sugars from lignocellulosic biomass, the process comprising:

(a) pretreating a feedstock comprising lignocellulosic biomass using digestion with an acid, solvent for lignin, and water;

(b) drying pretreated feedstock from step (a) to produce a dried feedstock with a moisture content of about 5 wt % or less;

(c) introducing the dried feedstock and a solid hydrolysis catalyst into a hydrolysis reactor;

(d) in the hydrolysis reactor, hydrolyzing the dried feedstock in the presence of the hydrolysis catalyst and under effective hydrolysis reactor conditions, to reach at least 50% conversion of cellulose to sugars, wherein the sugars are in combination with residual solids comprising lignin and the hydrolysis catalyst;

(e) washing and/or separating the sugars from the residual solids;

(f) combusting the residual solids to burn the lignin and produce an ash stream comprising the hydrolysis catalyst;

(g) recycling at least a portion of the ash stream comprising the hydrolysis catalyst to the hydrolysis reactor; and

(h) recovering or further processing the sugars.

Other variations provide a process for producing sugars from lignocellulosic biomass, the process comprising:

(a) pretreating a feedstock comprising lignocellulosic biomass using digestion with an acid, solvent for lignin, and water;

(b) drying a feedstock comprising lignocellulosic biomass to produce a dried feedstock with a moisture content of about 5 wt % or less;

(c) introducing the dried feedstock and a solid hydrolysis catalyst into a hydrolysis reactor;

(d) in the hydrolysis reactor, hydrolyzing the dried feedstock in the presence of the hydrolysis catalyst and under effective hydrolysis reactor conditions, to reach at least 50% conversion of cellulose and hemicellulose to sugars, wherein the sugars are in combination with residual solids comprising lignin and the hydrolysis catalyst;

(e) washing and/or separating the sugars from the residual solids;

(f) separating the hydrolysis catalyst from the lignin to generate recovered hydrolysis catalyst and residual lignin, wherein the solvent for lignin from step (a), or a digestion liquor derived from step (a), is utilized to remove the lignin from the hydrolysis catalyst;

(g) recycling at least a portion of the recovered hydrolysis catalyst to the hydrolysis reactor; and

(h) recovering or further processing the sugars.

The sugars produced and recovered may be fermented or converted to various products. The fermentation product may include an oxygenated compound, such as (but not limited to) oxygenated compounds selected from the group consisting of ethanol, propanol, butanol, pentanol, hexanol, heptanol, octanol, glycerol, sorbitol, propanediol, butanediol, butanetriol, pentanediol, hexanediol, acetone, acetoin, butyrolactone, 3-hydroxybutyrolactone, and any isomers, derivatives, or combinations thereof

In some embodiments, the oxygenated compound is a C3 or higher alcohol or diol, such as 1-butanol, isobutanol, 1,4-butanediol, 2,3-butanediol, or mixtures thereof

The fermentation product may include a hydrocarbon, such as isoprene, farnasene, and related compounds.

Multiple fermentation products may be produced in a single fermentor, in co-product production or as a result of byproducts due to contaminant microorganisms. For example, during fermentation to produce lactic acid, ethanol is a common byproduct due to contamination (and vice-versa).

Multiple fermentation products may be produced in separate fermentors. In some embodiments, a first fermentation product, such as an organic acid, is produced from glucose (hydrolyzed cellulose) while a second fermentation product, such as ethanol, is produced from hemicellulose sugars.

In some embodiments, the fermentation product includes an enzymatically isomerized variant of at least a portion of the fermentable sugars. For example, the enzymatically isomerized variant may include fructose which is isomerized from glucose. In some embodiments, glucose, which is normally D-glucose, is isomerized with enzymes to produce L-glucose.

In some embodiments, the fermentation product includes one or more proteins, amino acids, enzymes, or microorganisms. Such fermentation products may be recovered and used within the process; for example, cellulase or hemicellulase enzymes may be used for hydrolyzing cellulose-rich solids or hemicellulose oligomers.

Business systems may be configured to carry out the methods described. Apparatus may be configured to carry out the processes described. The invention also includes products produced by the disclosed processes and methods.

In this detailed description, reference has been made to multiple embodiments of the invention and non-limiting examples relating to how the invention can be understood and practiced. Other embodiments that do not provide all of the features and advantages set forth herein may be utilized, without departing from the spirit and scope of the present invention. This invention incorporates routine experimentation and optimization of the methods and systems described herein. Such modifications and variations are considered to be within the scope of the invention defined by the claims.

All publications, patents, and patent applications cited in this specification are herein incorporated by reference in their entirety as if each publication, patent, or patent application were specifically and individually put forth herein.

Where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially.

Therefore, to the extent there are variations of the invention, which are within the spirit of the disclosure or equivalent to the inventions found in the appended claims, it is the intent that this patent will cover those variations as well. The present invention shall only be limited by what is claimed.

What is claimed is:

1. A process for producing sugars from lignocellulosic biomass, said process comprising:
(a) drying a feedstock comprising lignocellulosic biomass to produce a dried feedstock with a moisture content of about 5 wt % or less;
(b) introducing said dried feedstock and a solid hydrolysis catalyst into a hydrolysis reactor;
(c) in said hydrolysis reactor, hydrolyzing said dried feedstock in the presence of said hydrolysis catalyst and under effective hydrolysis reactor conditions, to reach at least 50% conversion of cellulose and hemicellulose to sugars, wherein said sugars are in combination with residual solids comprising lignin and said hydrolysis catalyst;
(d) washing and/or separating said sugars from said residual solids;
(e) combusting said residual solids to burn said lignin and produce an ash stream comprising said hydrolysis catalyst;
(f) recycling at least a portion of said ash stream comprising said hydrolysis catalyst to said hydrolysis reactor; and
(g) recovering or further processing said sugars.

2. The process of claim 1, wherein step (a) utilizes flue gas for said drying, wherein said flue gas is derived from said combusting in step (e).

3. The process of claim 1, wherein said moisture content is about 2 wt % or less.

4. The process of claim 1, wherein said solid hydrolysis catalyst is a clay mineral based on hydrous aluminum phyllosilicates.

5. The process of claim 1, wherein said solid hydrolysis catalyst is a mineral selected from the montmorillonites group of phyllosilicate minerals, the mica group of phyllosilicate minerals, the smectite group of phyllosilicate minerals, the illite group of phyllosilicate minerals, or the chlorite group of phyllosilicate minerals.

6. The process of claim 1, wherein said solid hydrolysis catalyst is a mineral selected from the Kaolin group including kaolinite, dickite, halloysite, nacrite, other polymorphs of Al₂Si₂O₅(OH)₄, and combinations thereof.

7. The process of claim 1, wherein said solid hydrolysis catalyst is a non-mineral, and wherein said solid hydrolysis catalyst is hydrated with H₂O.

8. The process of claim 1, wherein said hydrolysis reactor is a rotating reactor.

9. The process of claim 1, wherein said hydrolysis reactor is a fluidized reactor.

10. The process of claim 1, wherein step (d) is integrated with step (c) to separate said sugars from said residual solids within said hydrolysis reactor.

11. The process of claim 1, wherein step (d) comprises washing said residual solids and then separating said sugars from said residual solids.

12. The process of claim 1, wherein step (d) comprises separating at least some of said sugars from said residual solids and then washing said residual solids to recover additional sugars.

13. The process of claim 1, wherein step (d) comprises simultaneously washing and separating said sugars from said residual solids.

14. The process of claim 1, wherein step (c) and/or step (d) utilizes a solvent for lignin.

15. The process of claim 1, wherein said effective hydrolysis reactor conditions include a hydrolysis temperature of from about 50° C. to about 200° C. and a hydrolysis time of from about 30 minutes to about 24 hours.

16. The process of claim 1, wherein step (c) achieves at least 90% conversion of cellulose and hemicellulose to sugars.

17. The process of claim 1, wherein step (f) comprises separating out said hydrolysis catalyst from said ash stream, and then recycling recovered hydrolysis catalyst to said hydrolysis reactor.

18. The process of claim 1, wherein step (f) comprises recycling said at least a portion of said ash stream directly to said hydrolysis reactor.

19. A process for producing sugars from lignocellulosic biomass, said process comprising:
(a) pretreating a feedstock comprising lignocellulosic biomass using steam or hot-water extraction;
(b) drying pretreated feedstock from step (a) to produce a dried feedstock with a moisture content of about 5 wt % or less;
(c) introducing said dried feedstock and a solid hydrolysis catalyst into a hydrolysis reactor;
(d) in said hydrolysis reactor, hydrolyzing said dried feedstock in the presence of said hydrolysis catalyst and under effective hydrolysis reactor conditions, to reach at least 50% conversion of cellulose to sugars, wherein said sugars are in combination with residual solids comprising lignin and said hydrolysis catalyst;
(e) washing and/or separating said sugars from said residual solids;
(f) combusting said residual solids to burn said lignin and produce an ash stream comprising said hydrolysis catalyst;
(g) recycling at least a portion of said ash stream comprising said hydrolysis catalyst to said hydrolysis reactor; and
(h) recovering or further processing said sugars.

20. A process for producing sugars from lignocellulosic biomass, said process comprising:
(a) pretreating a feedstock comprising lignocellulosic biomass using digestion with an acid, a solvent for lignin, and water; (b) drying pretreated feedstock from step (a) to produce a dried feedstock with a moisture content of about 5 wt % or less;
(c) introducing said dried feedstock and a solid hydrolysis catalyst into a hydrolysis reactor;
(d) in said hydrolysis reactor, hydrolyzing said dried feedstock in the presence of said hydrolysis catalyst and under effective hydrolysis reactor conditions, to reach at least 50% conversion of cellulose to sugars, wherein said sugars are in combination with residual solids comprising lignin and said hydrolysis catalyst;
(e) washing and/or separating said sugars from said residual solids;
(f) combusting said residual solids to burn said lignin and produce an ash stream comprising said hydrolysis catalyst;
(g) recycling at least a portion of said ash stream comprising said hydrolysis catalyst to said hydrolysis reactor; and
(h) recovering or further processing said sugars.
